(19) United States
(12) Patent Application Publication
(10) Pub. No.: US 2010/0017480 A1
(43) Pub. Date: Jan. 21, 2010

(54) RECIPIENT SIDE GROUPING OF ADDRESSES

(75) Inventor: Frank L. Jania, Lane Chapel Hill, NC (US)

Correspondence Address: CANTOR COLBURN LLP - IBM FISHKILL, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/175,017

(22) Filed: Jul. 17, 2008

(51) Int. Cl. G06F 15/82

(52) U.S. Cl. 709/206

(57) ABSTRACT

A method for grouping addressees of a message based on groups defined by a recipient of the message includes receiving a message including a plurality of addressees; determining the addresses of the addressees; comparing the addresses to one or more groups maintained by the recipient of the message; and displaying the message, wherein the message includes one more of the groups maintained by the recipient in place of one or more of the addressees.

### BACKGROUND

This invention relates to messaging and, in particular, grouping of recipients of messages based on recipient side information.

Electronic communication between individuals is becoming more and more prevalent. For example, e-mail and instant messaging (IM) are fast replacing conventional letter writing for communication between individuals.

In some instances, the composer (or sender) of an electronic message may address the message to several recipients. This may be done by typing in several different addresses of different individuals, selecting a predefined group of individuals from a listing of predefined groups or a combination of both.

In many current applications there is system for identifying groups of people. In some of those applications the group definitions are shared (e.g. Quickr), in others they are not (e.g. e-mail, IM). The latter allows communication with members of the group, as defined by the sender of the communications. For example, when a sender sends an email to “Best Friends Forever” everyone in the sender's group called “Best Friends Forever” is sent the message. The recipient of the message may receive the message with an indication of all others that received the message.

### SUMMARY

One embodiment of the present invention is directed to a method for grouping addressees of a message based on groups defined by a recipient of the message. The method of this embodiment includes receiving a message including a plurality of addressees; determining the addresses of the addressees; comparing the addresses to one or more groups maintained by the recipient of the message; and displaying the message, wherein the message includes one more of the groups maintained by the recipient in place of one or more of the addressees.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 shows a system on which embodiments of the present invention may be implemented;

FIG. 2 shows a block diagram of a method of group addresses according to one embodiment of the present invention;

FIG. 3 shows a block diagram of additional, optimal portions of the method shown in FIG. 1; and

FIG. 4 shows an example of a system according to one embodiment of the present invention that may be implemented on the system shown in FIG. 1.

The detailed description explains the preferred embodiments of the invention, together with advantages and features, by way of example with reference to the drawings.

### DETAILED DESCRIPTION

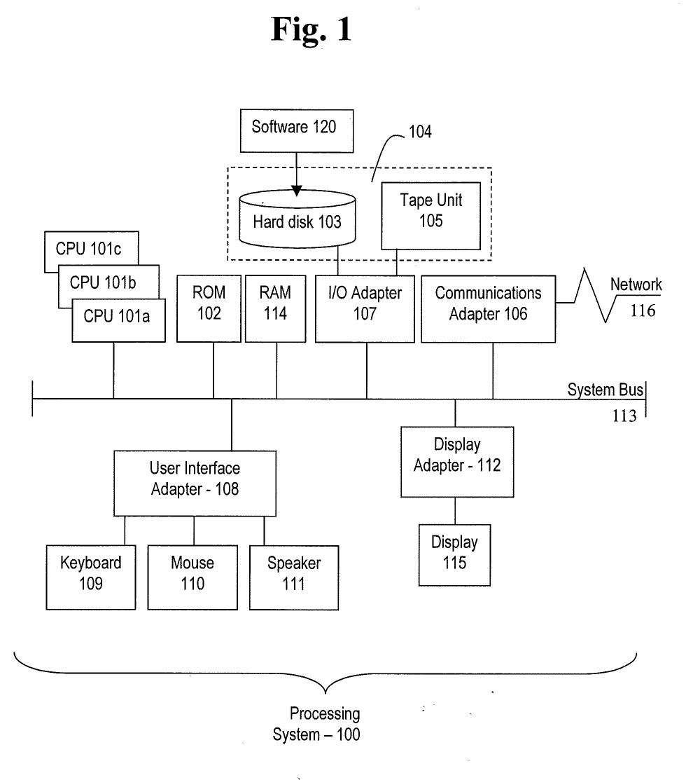

Referring to FIG. 1, there is shown an embodiment of a processing system 100 for implementing the teachings herein. In this embodiment, the system 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 114 and various other components via a system bus 113. Read only memory (ROM) 102 is coupled to the system bus 113 and may include a basic input/output system (BIOS), which controls certain basic functions of system 100.

FIG. 1 further depicts an input/output (I/O) adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. A network adapter 106 interconnects bus 113 with an outside network 116 enabling data processing system 100 to communicate with other such systems. A screen (e.g., a display monitor) 115 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Components Interface (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

Thus, as configured in FIG. 1, the system 100 includes processing means in the form of processors 101, storage means including system memory 114 and mass storage 104, input means such as keyboard 109 and mouse 110, and output means including speaker 111 and display 115. In one embodiment, a portion of system memory 114 and mass storage 104 collectively store an operating system such as the AIX® operating system from IBM Corporation to coordinate the functions of the various components shown in FIG. 1.

It will be appreciated that the system 100 can be any suitable computer or computing platform, and may include a terminal, wireless device, information appliance, device, workstation, mini-computer, mainframe computer, personal digital assistant (PDA) or other computing device.

Examples of operating systems that may be supported by the system 100 include Windows 95, Windows 98, Windows NT 4.0, Windows XP, Windows 2000, Windows CE, Windows Vista, Macintosh, Java, LINUX, and UNIX, or any other suitable operating system. The system 100 also includes a network interface 106 for communicating over a network 116. The network 116 can be a local-area network (LAN), a metro-area network (MAN), or wide-area network (WAN), such as the Internet or World Wide Web.

Users of the system 100 can connect to the network through any suitable network interface 116 connection, such as standard telephone lines, digital subscriber line, LAN or WAN links (e.g., T1, T3), broadband connections (Frame Relay, ATM), and wireless connections (e.g., 802.11(a), 802.11(b), 802.11(g)).

As disclosed herein, the system 100 includes machine readable instructions stored on machine readable media (for example, the hard disk 104) for capture and interactive display of information shown on the screen 115 of a user. As discussed herein, the instructions are referred to as “software” 120. The software 120 may be produced using software development tools as are known in the art. Also discussed herein, the software 120 may also referred to as a “command line testing tool” 120, an “a testing interface” 120 or by other similar terms. The software 120 may include various tools and features for providing user interaction capabilities as are known in the art.

In some embodiments, the software 120 is provided as an overlay to another program. For example, the software 120 may be provided as an “add-in” to an application (or operating system). Note that the term “add-in” generally refers to supplemental program code as is known in the art. In such embodiments, the software 120 may replace structures or objects of the application or operating system with which it cooperates.

The software 120 generally provides users with a capability to thoroughly and automatically test commands that issue from a command line. The commands may be native to (written to function within) computer application code programs (for example, C, C++, Perl, Java and others), other programs typically regarded as computing environments (UNIX, LINUX, DOS, and others) as well as other types of programs.

One application conventionally used in such systems are electronic communications. Examples include e-mail and instant messaging (IM). In addition, the teachings herein may be applied in other contexts as well such as, for example, text messaging on cellular phones. As used herein, a “message” shall refer to any type of electronic message, regardless of the manner in which it was sent. While the following example is directed to e-mail communications, the teachings are not limited thereto and could be applied to any type of electronic messaging.

As discussed above, when a message is received by a recipient, the message typically includes an indication of all the recipients of the message. In some cases, the message is addressed to a sender predefined group of recipients. In some cases, the application may allow a recipient to the addressees included in the pre-defined group. For example, clicking on the group may show all the members of the group. In other cases, the addressees may be a list of individuals in addition to the group.

Regardless, embodiments of the present invention are directed to converting the addresses list on a particular message into groups defined by the recipient. For instance, suppose is message is sent to persons A, X, Y and Z. Suppose further that person A has defined a group called “TEST GROUP” composed of persons X and Y. In such a case, embodiments of the present invention may be directed to displaying that the massage is directed to at least “TEST GROUP” and “Z.” As will be discussed in greater detail below, the actual names displayed may vary depending on the embodiment. In short, however, to the extent that an address list for a message contains persons that form, or nearly form, a group defined by a recipient, the recipients group name that includes those persons is shown in the address list. The term “person” as used herein shall refer to any entity, be it a single person, multiple persons, company, etc. that has unique electronic communication address. For instance, the addressee “help desk” which may direct a message to any one or more of a group of individuals responsible for answering information technology (IT) questions within a company, may be considered a “person” herein.

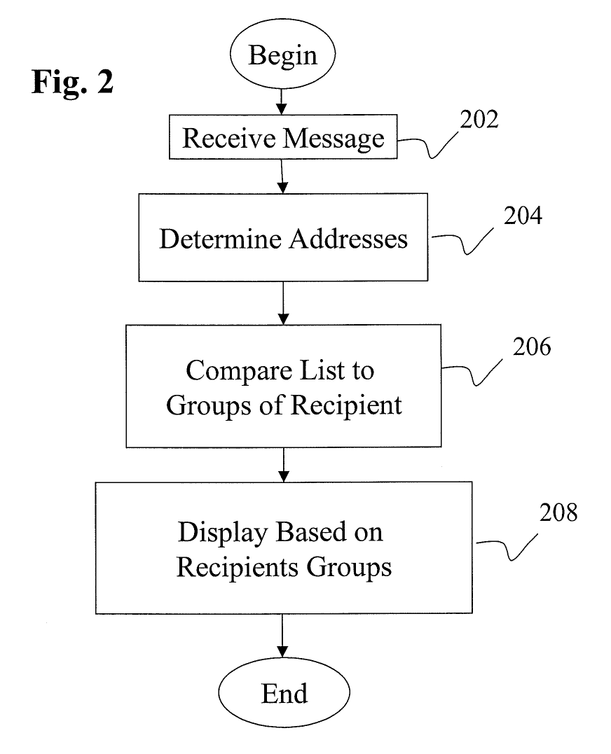

FIG. 2 shows a flow diagram of a method according to one embodiment of the present invention. At a block 202, a message is received. The message may include a recipient list that lists persons including, and in addition. to the message recipient. The addressees on the recipient list may also include groups that were defined by the sender. In some embodiments, the “groups” may be entity wide groups. That is, in an entity such as a corporation, all users may have access to global groups in their electronic communications applications that any user may select from a “global address book.”

At a block 204 the addressees (recipient list) for the message are determined. This may include examining each address on the recipient list to determine if the address is a group. If an address is a group, the recipients that comprise the group may be considered individually in place of the group or the group itself may be displayed. Regardless, each addressee of the group, whether displayed or not, is determined.

At block 206, the recipient list is compared to groups defined by the recipient of the message. In one embodiment, the definition of the recipient groups may be stored locally in the electronic communications application operating on the recipients computing device. Of course, the group definitions could be stored in a location remote from the recipient's computing device, such as a server.

At a block 208, the communication is displayed to the recipient with the groups of the recipient included in the recipient list. The displaying may take on different forms based on different embodiments of the present invention. For example, the recipient group(s) that include the recipients of the message may replace the original recipient list; the recipient group name may replace the sender's group name; the recipient's group names may be displayed in addition to the original recipient list; or a visual modification to the recipient list may be otherwise made. Of course, other modifications could also be made.

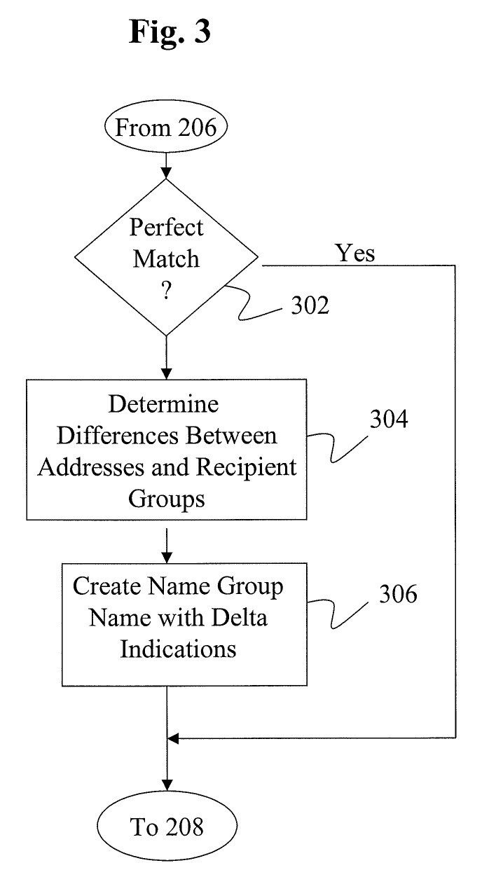

FIG. 3 shows additional, optional portions of the method shown in FIG. 2. If implemented, at a block 302 (following block 206; FIG. 2) it is determined if a perfect match between a recipient group and the recipient list exist. A perfect match may exist, for example, if a recipient group includes x number of members and each of the members is included in the recipient list.

If a perfect match exists, the process returns to block 208 (FIG. 2). Otherwise, at a block 304, differences between the recipient group and the address list are determined. For example, the recipient list may include all of the members a particular recipient group with one more recipient. As another example, the recipient list may include one or more less members of a particular recipient group. At a block 306 group names (from the recipient's group) having indications of the addresses in addition to or missing from the recipient's groups are created. Processing then returns to block 208.

Examples of the groupings that may be created according to embodiments of the present invention are now discussed. Each of the following examples assumes that a particular recipient has defined a group “Seven-Dwarfs” that includes the members Sleepy, Sneezy, Happy, Grumpy, Dopey, Bashful and Doc. Of course, each of these members may have a particular electronic communication address associated therewith. For example, “Sleepy” may actually refer to e-mail address sleepydwarf54321@fantasycharacters.com.

As a first example, the sender's address list may be represented as follows:

### To: Sleepy, Sneezy, Happy, Grumpy, Dopey, Bashful, Doc

According to this example, the recipient's address list may be represented as follows:

### To: Seven-Dwarves.

This example shows the case where a perfect match was found and the original list was replaced by a group of from the recipient's group name.

As another example, the sender's list may be represented as follows:

### To: Sleepy, Sneezy, Happy, Grumpy, Dopey, Bashful, Doc, Snow White

According to this example, the recipient's address list may be represented as follows:

### To: Seven-Dwarves (+Snow White)

This example shows the case where a perfect match was found and the original list was replaced by a group of from the recipient's group name and the additional recipient was shown as the delta indication. This may occur, for example, at block 306 as described above.

As another example, the sender's list may be represented as follows:

### To: Sleepy, Sneezy, Happy, Grumpy, Dopey, Bashful,

According to this example, the recipient's address list may be represented as follows:

### To: Seven-Dwarves (-Doc)

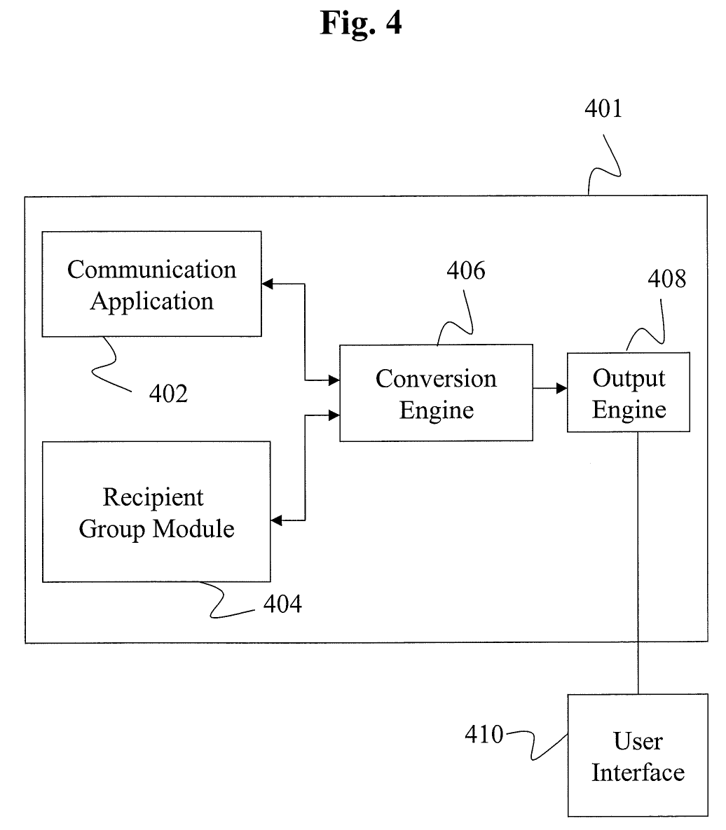

FIG. 4 shows an example of a system 401 which may be implemented to carry out the present invention. This system may be implemented, for example, on the computing system shown in FIG. 1. Of course, the system 401 could be implemented on other devices capable of receiving electronic communications such as, for example, a mobile phone, a personal digital assistant (PDA), a pocket PC, or the like.

The system 401 includes a communication application 402. The communication application 402 could be any type of application configured to handle the reception of electronic communications. In general, the communication application 302 receives and stores electronic messages addressed to at least one of the message recipients of a message.

The system 401 may also include a recipient group module 404. The recipient group module 404 contains, in one embodiment, groups defined by the recipient as described above.

Both the communication application 402 and the recipient group module 404 may be coupled to a conversion engine 406. The conversion engine 406 may be configured to perform any or all of the methods described above. In general, the conversion engine 406 converts the recipient list as received to groupings as described herein.

The conversion engine 406 may coupled to an output engine 408 that, based on information received from the conversion engine 406 may alter the presentation format of the recipient list of a message.

The system 401 may be coupled to a user interface 410 for displaying the re-formatted message to a user.

The capabilities of the present invention can be implemented in software, firmware, hardware or some combination thereof. As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately. Additionally, at least one program storage device readable by a machine, tangibly embodying at least one program of instructions executable by the machine to perform the capabilities of the present invention, can be provided.

The flow diagrams depicted herein are just one example. There may be many variations to this diagram or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for grouping addressees of a message based on groups defined by a recipient of the message, the method comprising:
receiving a message including a plurality of addressees;
determining the addresses of the addressees;
comparing the addresses to one or more groups maintained by the recipient of the message; and
displaying the message, wherein the message includes one more of the groups maintained by the recipient in place of one or more of the addressees.
